(19) United States
(12) Patent Application Publication
(10) Pub. No.: US 2008/0169131 A1
(43) Pub. Date: Jul. 17, 2008

(54) Device And Method For Measuring Load Weight On Working Machine

(76) Inventors: Shu Takeda, Tochigi (JP); Minoru Wada, Tochigi (JP); Genichiro Watanabe, Tochigi (JP); Yoshiaki Saito, Tochigi (JP)

Correspondence Address: POSZ LAW GROUP, PLC, 12040 SOUTH LAKES DRIVE, SUITE 101, RESTON, VA, 20191, US

(21) Appl. No.: 11/885,338

(22) PCT Filed: Jan. 10, 2006
(86) PCT No.: PCT/JP2006/304607

§ 371 Date: Aug. 30, 2007

(30) Foreign Application Priority Data
Mar. 15, 2005 (JP) 2005-072360

(51) Int. Cl. G01G 19/08; G01G 19/14; G06F 19/00

(52) U.S. Cl. 177/136; 177/145; 702/174

(57) ABSTRACT

A working machine such as a wheel loader for moving a load measures the weight of the load accurately. While the load is lifted by a boom of the working machine, a boom angle (θ) and a pressure value (P) of a boom cylinder are measured and a boom angular speed (ω) is calculated. A corrected factor (α) is determined according to the boom angular speed (ω), and a corrected pressure value (P′) is calculated from “P′=P−αω.” A predetermined table is referred to and the weight (W) of the load is determined based on the boom angle (θ) and the corrected pressure value (P) of the boom cylinder. Further, calibrations are performed as needed, and each time when a calibration is made, the average value of the calibrated value and the preceding calibrated value is calculated and data is rewritten to this average value.

### FIELD OF THE INVENTION

The present invention relates to a working machine that moves a load, and more particularly to a device and method for measuring load weight.

### DESCRIPTION OF THE RELATED ART

Conventionally, it is known that a machine used to load dump trucks and other delivery vehicles, such as a wheel loader, employs a load weight measurement device that measures, during boom operation, the weight of the load carried in the bucket and indicates the weight (See Patent Document 1).

According to the conventional art described in the above document, after the boom begins moving, a prescribed calculation is performed utilizing a numerical table pre-calculated from the boom angle and the difference between the boom cylinder head pressure and bottom pressure, to measure the load weight carried in the bucket.

Patent Document 1: Japanese Patent Application Laid-open No. 2001-99701

### BRIEF SUMMARY OF THE INVENTION

### Problems to be Solved by the Invention

However, since the conventional art described in the afore-mentioned Patent Document 1 does not take into consideration error factors such as the frictional force generated in the mechanism used to lift the load (hereinafter “lifting mechanism”), or changes in the weight, due to wearing, damage, repair, or replacement of the lifting mechanism components such as bucket or teeth, there is demand to further improve the measurement accuracy.

Accordingly, an object of the present invention is to improve the measurement accuracy of the load weight moved by a working machine.

### Means of Solving the Problems

According to an aspect of the present invention, a working machine for moving a load comprises: a lifting unit for lifting a load; a displacement detection device for detecting the displacement of the lifting unit; an actuator for driving the lifting unit; and a measurement device for measuring the output value or input value of the lifting unit; and further a detection value acquiring means for acquiring, during operation of the lifting unit, the displacement from the displacement detection device and the output value or input value from the measurement device; a speed calculating means for obtaining the movement speed of the lifting unit during operation of the lifting unit; a correcting means for obtaining the corrected value by correcting the output value or input value of the actuator in accordance with the movement speed of the lifting unit; and a means for calculating the load weight based on the corrected value obtained by correcting the output value or input value of the actuator, and the lifting unit displacement obtained from the detection value acquiring means.

According to this working machine, the input value or output value of the actuator is corrected in accordance with the operation speed of the lifting unit, and the load weight is calculated using this corrected value. This allows the error factors that change depending on the operation speed of the lifting unit, for example forces such as frictional force, to be taken into consideration to obtain measurement results of higher accuracy.

In an embodiment of the present invention, a hydraulic cylinder is used as an actuator and the pressure difference between the hydraulic cylinder head pressure and bottom pressure is measured to be used as the actuator output value. However, this is just an example, and the present invention can be applied to working machines employing other types of actuators, and an input value can also be measured for use in place of, or together with, the actuator output value. For example, if an electric motor is used as an actuator, the output torque and rotating speed can be measured as the output value of the electric motor, or the input current and input voltage, which are input values, can be detected as well.

Further, in an embodiment of the present invention, the lifting unit of the working machine has a boom, the actuator includes a hydraulic cylinder for moving the boom, the measurement device includes a pressure detection device for detecting the hydraulic cylinder pressure; and the displacement detection device includes an angle detection device for detecting the angle of the boom. This configuration applies to working machine that raises and lowers a load using a boom, such as a wheel loader, power shovel, or a crane, for example. However, the present invention also applies to working machines that do not have a boom, such as a winch.

Further, in an embodiment of the present invention, the correcting means may calculate the correction factor from the movement speed of the lifting unit and the output value or input value of the actuator and correct the output value or input value of the actuator based on the correction factor and the lifting unit movement speed. According to this configuration, error factors that change in response to the output value or input value of the actuator or the movement speed of the lifting unit can be taken into consideration.

Further, in an embodiment of the present invention, the correcting means may comprise a speed correction table defining the correlation among the output value and input value of the actuator, the lifting unit movement speed, and the correction factor, that is used to calculate the correction factor. A constant can also be used as a correction factor.

For the working machine having a boom, the boom angular speed, for example, can be used as the above-mentioned movement speed, but this is nothing more than just an illustration. For example, a variety of movement speeds related to the movement of the lifting unit, including the boom hoisting speed, bucket hoisting speed, movement speed of the hydraulic cylinder piston that moves the lifting unit, or the rotational speed of the hydraulic or electric motor that moves the lifting unit, can be used for the above-mentioned correcting process.

According to another aspect of the present invention, a working machine comprises a lifting unit for lifting a load; a displacement detection unit for detecting displacement of the lifting unit; an actuator for driving the lifting unit; and a measurement unit for measuring the output value and input value of the actuator; and further comprises a load weight calculating means having a load weight calculation table defining the correlations among the output value or input value of the actuator, the displacement of the lifting unit, and the load weight; that acquires, during operation of the lifting unit, the displacement from the displacement detecting device and the output value or input value from the measurement device; and that calculates the load weight referring to said load weight calculation table, based on said displacement acquired from said displacement detecting device and said output value or input value acquired from said measurement device; and a calibrating means that inputs the specified load weight value; acquires, during calibration operation of the lifting unit, the displacement from the displacement detection device and the output value or input value from the measuring device; and calibrates the load weight calculation table based on the displacement acquired from the displacement detecting device, the output value or input value acquired from the measurement device, and the specified load weight.

According to this working machine, the load weight specification is input, and during the calibration operation the displacement is acquired from the displacement detection device and the output value or input value is acquired from the measuring device, and the load weight calculation table is calibrated based on the displacement acquired from the displacement detection device, the output value or input value acquired from the measuring device, and the specified load weight. Occasionally executing this type of calibration eliminates error factors due to changes in the weight of the lifting unit resulting from wearing, damage, corrosion, etc., of the components of the lifting unit to make measurement of greater accuracy possible.

An embodiment of the present invention is a working machine further comprising a speed calculating means for obtaining the movement speed of the lifting unit during movement of the lifting unit; and a correcting means for obtaining a corrected value by correcting the output value or input value of the actuator according to the speed, wherein the load weight calculation table records the corrected value for the output value or input value of the actuator and the numerical value for obtaining the load weight based on the displacement of the lifting unit; and wherein the load weight calculating means calculates the load weight referring to the load weight calculation table, based on the corrected value from the correcting means and the acquired load lifting unit displacement, and calibrates the load weight calculation table numerical values. This makes it possible to take into consideration the error factors (frictional force for example) that change depending on the movement speed of the lifting unit to obtain measurement results of greater accuracy.

Further, in an embodiment of the present invention, the calibrating means calculates, during calibration execution, the average value of the numerical value acquired from the current calibration and the numerical value currently registered in the load weight calculation table, and then uses the calculated average value as the post-calibration numerical value for calibrating the load weight calculation table. According to this configuration, the data acquired from the calibration during calibration of the load weight calculation table is not used to update the load weight calculation table but rather the average value of the data acquired from the calibration and the existing data of the load weight calculation table is obtained and this average value is used to update the load weight calculation table so that in the event the data received from the calibration is not a correct value, the effect of this error will not be 100%.

Further, an embodiment of the present invention further comprises a clearing means that initializes the load weight calculation table numerical values to the specified initial values. By performing this initialization process, the load weight calculation table returns to the state it was in at the time it was shipped from the factory. When calibration has been repeated many times to date, or when the lifting unit of the working machine has been significantly repaired or replaced, there are cases when there is some concern about the reliability of the numerical values in the current load weight calculation table. In such a case, it is effective to newly conduct calibration after conducting the afore-mentioned initialization process.

Another aspect of the present invention provides a device and means for measuring the weight of the load transported by a working machine in accordance with the afore-mentioned principles. Further, another aspect of the present invention provides a computer program that commands a computer to perform the load weight measurement method.

### BRIEF DESCRIPTION OF THE DRAWINGS

FIG. 1 is a configuration drawing of an external view of a wheel loader relating to the present embodiment;

FIG. 2 is a configuration drawing of a load weight measurement system;

FIG. 3 is a flow chart showing the flow of the overall control relating to a controller 11 of the present invention;

FIG. 4 is a function block diagram of the part of the controller 11 that performs the load weight measurement;

FIG. 5 is a table that shows an example of a load weight calculation table;

FIG. 6 is a table that shows an example of a speed correction table;

FIG. 7 is a flow chart showing details of the load weight measurement operation flow;

FIG. 8 is a flow chart showing the process for the load weight table calibration operation.

### DETAILED DESCRIPTION OF THE INVENTION

The following describes details of an embodiment of the present invention with reference to the drawings.

The embodiments shown below apply the present invention to a wheel loader as an example of a working machine to make this explanation easy to understand, but in addition to a wheel loader the present invention can be applied to a variety of working machines having a lifting function including but not limited to power shovels, cranes, and winches.

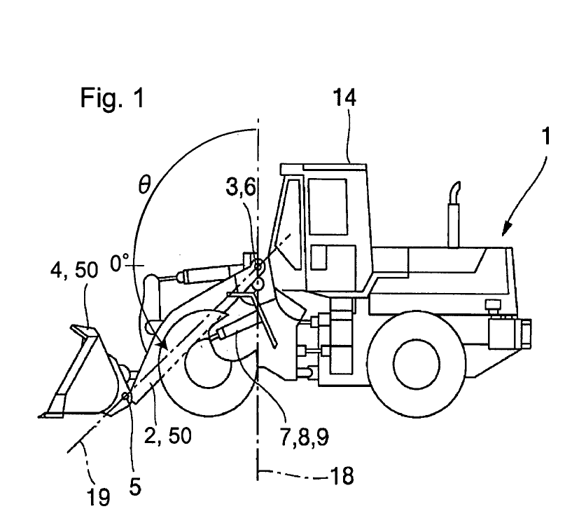

FIG. 1 is a configuration drawing of an external view of a wheel loader 1.

The wheel loader 1 is provided with, as the lifting unit, a boom 2 that freely rotates around a boom pin 3 attached to a rear anchor unit, and a bucket 4 that freely rotates around a bucket pin 5 attached to an end of boom 2. In the vicinity of the boom pin 3 is provided a boom angle detection device 6, such as a potentiometer, that detects the displacement of the boom 2, for example, the lift angle (θ) (hereinafter “boom angle”). As shown in FIG. 1, the boom angle (θ) is measured in the counterclockwise direction, the angle between the perpendicular line 18 passing through the boom pin 3 and the straight line 19 that connects the boom pin 3 to the bucket pin 5 that attaches the end of the boom 2 to the bucket 4. In addition, when the straight line 19 that connects the boom pin 3 to the bucket pin 5 is horizontal, the boom angle (θ) is defined as “boom angle (θ)=0 degrees.” Further, the wheel loader 1 is provided with a hydraulic cylinder (hereinafter “boom cylinder”) 7 that raises the boom 2, and the boom cylinder 7 is provided with a head pressure detection device 8 and a bottom pressure detection device 9 that detect the head pressure and bottom pressure, respectively. The substantial output pressure value and input pressure value of the boom cylinder 7 is the pressure difference (P) between the afore-mentioned head pressure and bottom pressure. Here, this pressure difference (P) is called the boom cylinder pressure value (P).

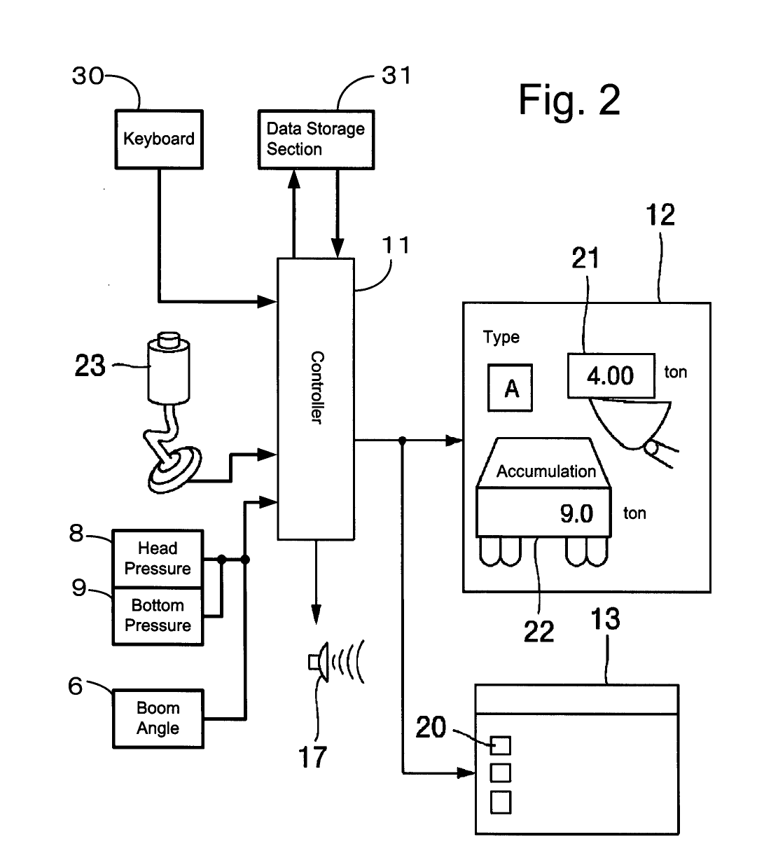

FIG. 2 is a configuration drawing of a load weight measurement system installed in the wheel loader 1.

As shown in FIG. 2, the wheel loader 1 is provided with a controller 11 comprising a microprocessor or the like that is electrically connected to the afore-mentioned boom angle detection device 6, head pressure detection device 8, and bottom pressure detection device 9 as well as a keyboard 30 and a data storage section 31. The keyboard 30 is installed in a driver's cabin 14 and is used for inputting, among other data, the hereafter-mentioned calibration signal for specifying the start of calibration operation and the load weight value that specifies the weight of the load that can be lifted. In addition, the data storage section 31 stores in advance the hereafter-mentioned load weight calculation table 63 and a speed correction table 64.

Further, the controller 11 is connected to a display 12 installed in the driver's cabin 14. The display 12 is provided with a load weight display section 21 that shows the load weight (W) in the bucket 4 and a cumulative load weight display section 22 that shows the cumulative weight that has been loaded to date. In addition, the controller 11 is connected to a printer 13 that prints out the load weight and cumulative load weight in accordance with the instruction from a print switch 20. Also, a lever 23 and a buzzer 17 are electrically connected to the controller 11. The lever 23 is provided in the driver's cabin 14 and is operated by the operator of the wheel loader 1 (hereinafter “operator”) to move the boom 2 and the bucket 4. In addition, the buzzer 17 is provided in the driver's cabin 14 and buzzes to warn the operator when the load weight loaded in the bucket 4 is an overload.

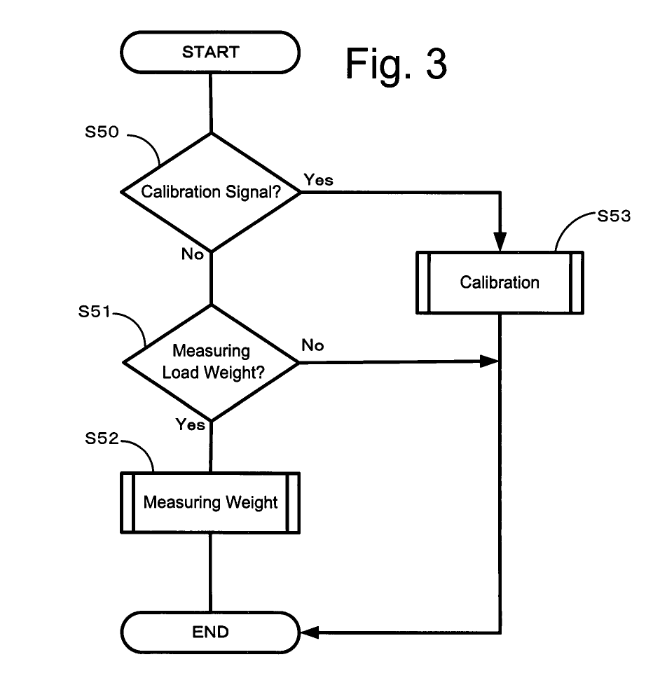

Next, FIG. 3 is used to explain the load weight (W) measurement flow processed by the controller 11. In the following flow charts, “Step” is abbreviated as “S.”

As shown in FIG. 3, the controller 11 determines whether or not a calibration signal is being input (S50). The calibration signal is input by the operator using the keyboard 30. When the controller 11 determines that a calibration signal has been input, it performs the hereafter-mentioned calibration operation (S53), and if it determines that a calibration signal has not been input, it determines whether or not it is necessary to perform load weight measurement using the specified determination conditions each time the boom 2 is moved (S51). Then, when the controller 11 determines that it is necessary to perform load weight measurement, it performs the load weight measurement that is described in detail hereafter (S52).

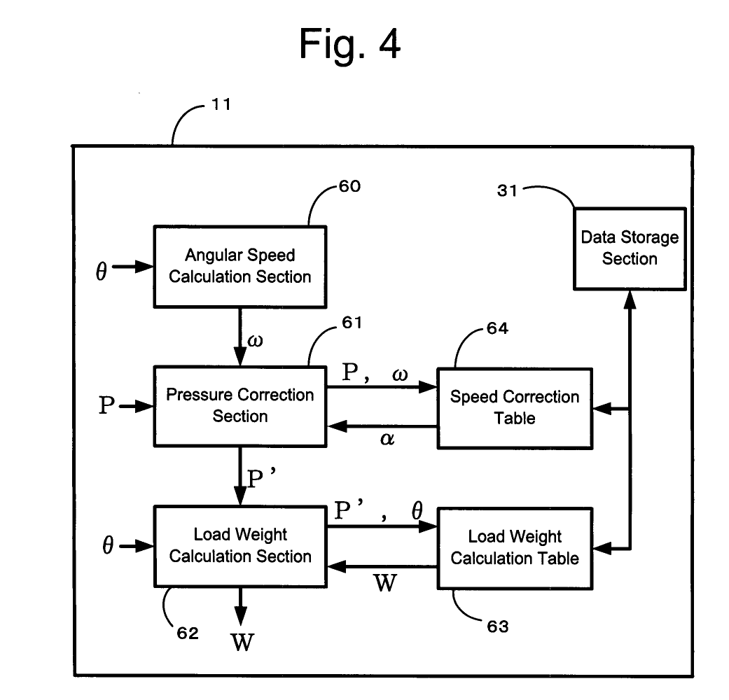

FIG. 4 shows a function block diagram of the part of the controller 11 that measures the load weight.

As shown in FIG. 4, the controller 11 has an angular speed calculation section 60, a pressure correction section 61, and a load weight calculation section 62, and, further, the data storage section 31 contains a load weight calculation table 63 and a speed correction table 64.

The angular speed calculation section 60 repeatedly inputs the boom angle (θ) several times at a fixed interval during operation of the boom 2 and calculates the angular speed of the boom 2 (ω) at the time of each input (hereinafter “boom angular speed”). Here, the boom angular speed (ω) is the rotational speed per unit time of the boom 2.

The pressure correction section 61 repeatedly inputs the boom cylinder pressure value (P) detected from the afore-mentioned head pressure detection device 8 and the bottom pressure detection device 9 at a fixed interval during operation of the boom 2 while also inputting the boom angular speed (ω) at the time of each input calculated by the angular speed detection section 60. Next, the pressure correction section 61 refers to the speed correction table 64 based on the boom cylinder pressure value (P) and the boom angular speed (ω) at the time of each input and calculates a correlation factor (α) in accordance with the combination of the boom cylinder pressure value (P) and the boom angular speed (ω). In the afore-mentioned speed correction table 64 is recorded the various correction factors (α) corresponding to the boom cylinder pressure value (P) and boom angular speed (ω) values. This correction factor (α) value is a value included in the boom cylinder pressure value (P), used to correct the error factors that change in accordance with the boom angular speed (ω), such as friction for example. Then, the pressure correction section 61 utilizes the calculated correction factor (α), boom cylinder pressure value (P), and the boom angular speed (ω) to calculate the speed corrected pressure value (hereinafter “corrected pressure value”) (P′) in accordance, for example, with the formula “P′=P−αω.”

The load weight calculation section 62 enters the corrected pressure value (P′) and the boom angle (θ) at the time of each input for each of the afore-mentioned set intervals, refers to the load weight calculation table 63, and calculates the load weight (W) corresponding to the corrected pressure value (P′) and boom angle (θ) combination. In addition, the afore-mentioned load weight calculation table 63 records the correlation among various corrected pressure values (P′), the boom angle (θ), and the load weight (W). Based on the numerical values recorded in the afore-mentioned load weight calculation table 63, the load weight (W) corresponding to the corrected pressure value (P′) and boom angle (θ) combination is calculated at the time of each input, and then the most accurate load weight (W) is calculated based on load weight (W) at a plurality of inputs.

Next, the load weight calculation table 63 and speed correction table 64 are explained.

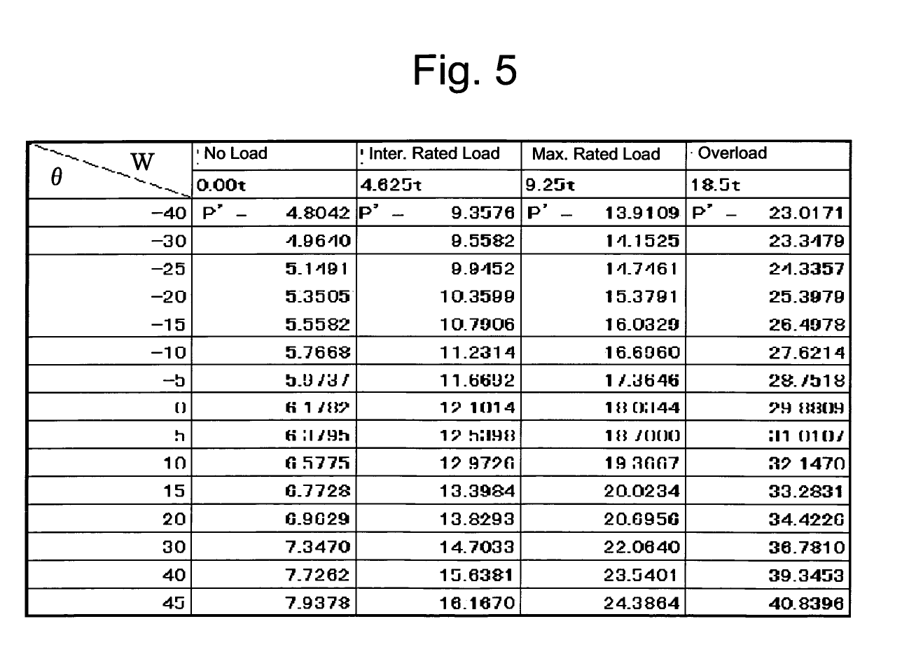

FIG. 5 shows an example of the load weight calculation table 63.

As shown in FIG. 5, the load weight calculation table 63 shows the correlation among the load weight (W), the boom angle (θ), and the corrected pressure value (P′). More specifically, when there are several representative values for the load weight (W) in the load weight calculation table 63, for example, W=0 t (status when there is no load), 4.625 t (intermediate rated load), 9.25 t (maximum rated load), and 18.5 t (overload), the corrected pressure value (P′) for the various values within the boom angle (θ) variable range, for example −40 degrees to +45 degrees, is recorded.

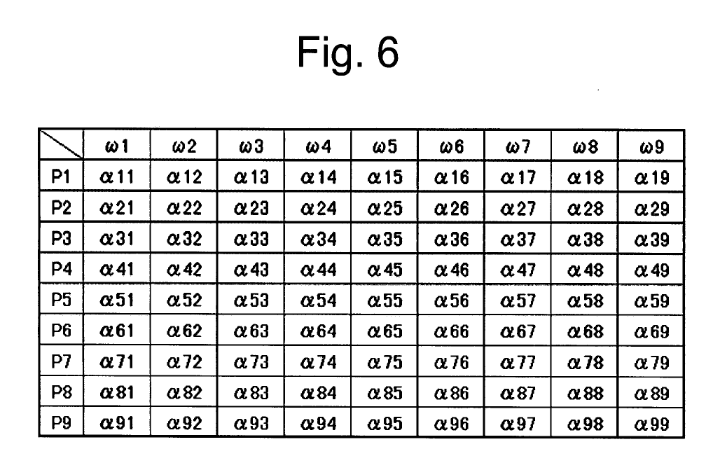

FIG. 6 shows an example of the speed correction table 64.

As shown in FIG. 6, the speed correction table 64 shows the correlation among the correction factor (α), the boom cylinder pressure value (P), and the boom angular speed (ω). More specifically, the speed correction table 64 records the correction factor (α) values “a11 to a99” corresponding to the various combinations of the boom cylinder pressure values (P) “P1 to P9” and the various boom angular speeds (ω) “ω1 to ω9.” Note that in this embodiment the correction factor (α) is used as a function of the boom angular speed (ω) and the boom cylinder pressure value (P), but depending on the working machine the correction factor (α) can be a constant, either the boom angular speed (ω) or the boom cylinder pressure value (P) alone can be a variable of a function, or a different variable, such as the boom angle (θ) can be used as a variable of a function. The configuration of the speed correction table 64 can change depending on the circumstances, or, if the correction factor α is a constant, the speed correction table 64 is not necessary.

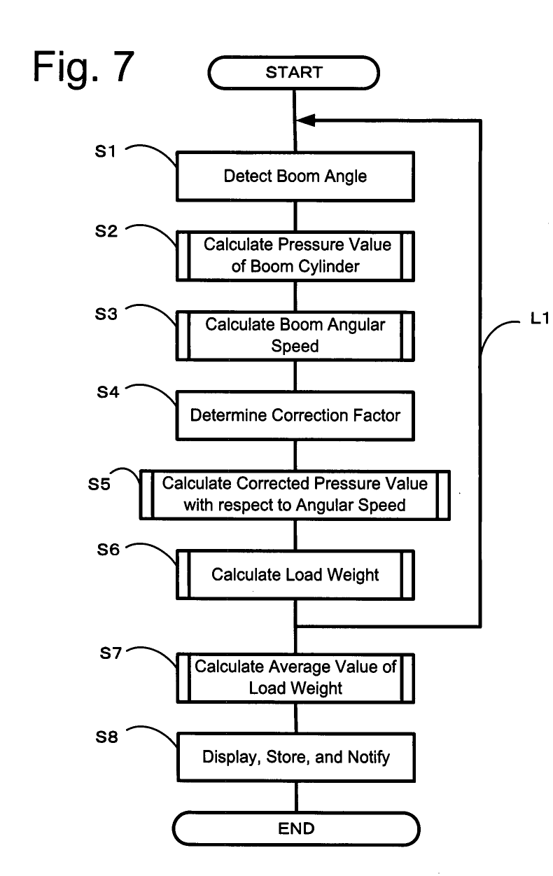

Next, FIG. 7 will be used to explain the load weight measurement operation (S52 of FIG. 3) process flow.

As shown in FIG. 7, this process is conducted during the movement of the boom 2, or more specifically while the load is being lifted. The controller 11 detects the current boom angle (θ) value of the boom 2 based on the output signal of the boom angle detection device 6 (S1). Next, the controller 11 inputs the head pressure and bottom pressure detected from the head pressure detection device 8 and the bottom pressure detection device 9 and calculates the difference to calculate the current boom cylinder pressure value (P) (S2). Next, the controller 11 utilizes the afore-mentioned current boom angle (θ) value and the boom angle (θ) value detected before the first cycle to calculate the boom angular speed (ω) using the prescribed calculation method (S3). Next, the controller 11 refers to the speed correction table (FIG. 6) to determine the correction factor (α) corresponding to the combination of the current boom angular speed (ω) and the boom cylinder pressure value (P) (S4). Next, the controller 11 substitutes the current boom angular speed (ω), the boom cylinder pressure value (P), and the correction factor (α) into the formula “P′=P−αω” to calculate the corrected pressure value (P′) (S5). The corrected pressure value (P′) is a value that subtracts the error components such as the frictional force, etc., that change according to the boom angular speed (ω), from the boom cylinder pressure value (P). Next, the controller 11 refers to the load weight calculation table 63 and calculates the load weight (W) corresponding to the combination of the current boom angle (θ) and corrected pressure value (P′) (S6). The load weight calculation table 63 only records numerical values for the load weight (W) representative values, so interpolation calculation is performed using these numerical values to calculate the current load weight (W).

The afore-mentioned Steps 1 (S1) to Step 6 (S6) are repeatedly executed a plurality of times at a constant interval using a repeat loop (L1). This is used to calculate the load weight (W) at a plurality of points during the movement of the boom 2. Also, the controller 11 averages the load weight (W) at a plurality of points to obtain the most accurate load weight (W) value (S7), and stores this in the data storage section 31, displays it on the display 12, and, further, checks if this value exceeds the overload value, and if it does, sounds the buzzer 17 to warn the operator (S8).

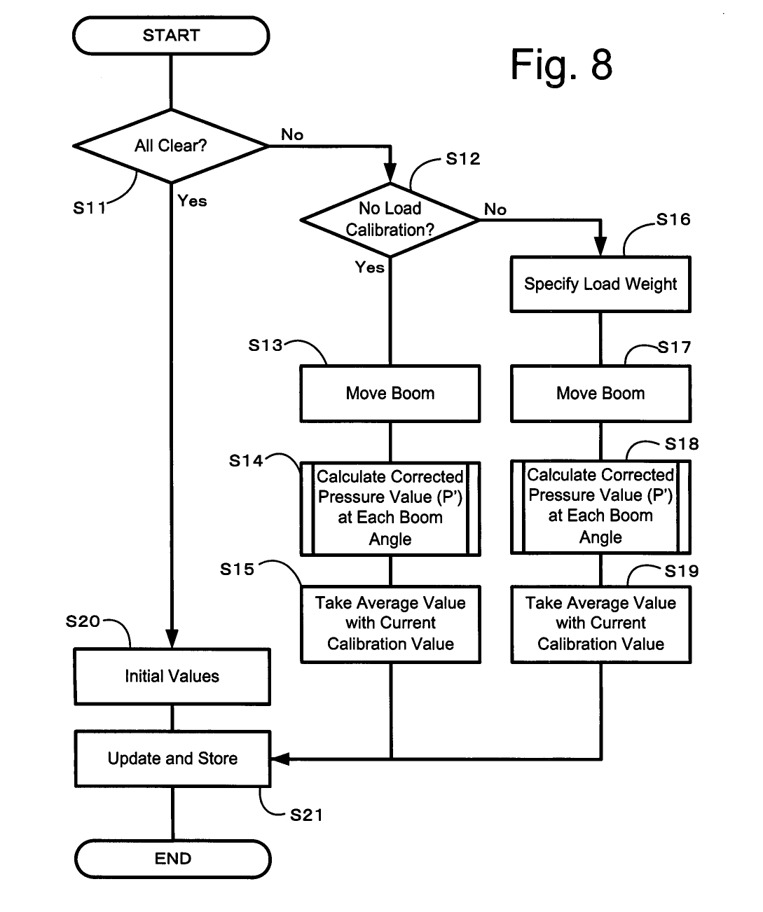

Next, FIG. 8 is used to explain the calibration operation (S53 of FIG. 3) process.

As shown in FIG. 8, the controller 11 determines whether or not an all clear signal has been entered by the operator using the keyboard 30 (S11). If an all clear signal has been entered (S11: Yes), the controller 11 clears all of the data in the load weight calculation table 63 and returns it to the previously provided initial values (S20). This action changes the contents of the load weight calculation table 63 to the same contents as at the time of factory shipment. In addition, if the all clear signal has not been input, the controller 11 determines if no-load calibration has been selected by the operator using the keyboard 30 (S12). If no-load calibration has been selected (S12: Yes), the controller 11 moves the boom 2 through the entire variable range of the boom angle (θ) (S13). In addition, in this case the bucket 4 is left empty.

Then, the controller 11 repeats the same process as Step 1 (S1) to Step 6 (S6) shown in FIG. 7 during the operation throughout the variable range of the boom to calculate the corrected pressure value (P′) corresponding to the values for the boom angle (θ) recorded in the load weight calculation table 63 (S14). Then, the controller 11 takes the average value of the corrected pressure value (P′) at each boom angle (θ) during the currently performed calibration and the corrected pressure value (P′) corresponding to the column when the load weight (W) of the load weight calculation table 63 is zero (no load) (S15), and then uses this average value to overwrite the corrected pressure value (P′) corresponding to the no-load column of the load weight calculation table 63 (S21).

In addition, in the afore-mentioned Step 12 (S12), when no-load calibration was not selected, the controller waits in the meantime for the operator to use the keyboard 30 to specify the load weight (S16). Here, the load weight that can be specified is either the intermediate rated load, the maximum rated load, or the overload recorded in the load weight calculation table 63. Together with this, the operator loads a load having the exact same weight as the afore-mentioned specified weight into the bucket 4. Then, after the afore-mentioned load has been loaded, the controller 11 moves the boom 2 through the entire variable range of the boom angle (θ) (S17). Then, the controller 11 repeatedly conducts the same process as for Steps 1 (S1) to Step 6 (S6) as shown in FIG. 7 while the boom is moving through the entire variable range and then calculates the corrected pressure value (P′) corresponding to the values for the boom angle (θ) recorded in the load weight calculation table 63 (S18). Then, the controller 11 takes the average value of the corrected pressure value (P′) at each boom angle (θ) during the currently performed calibration and the corrected pressure value (P′) corresponding to the column when the load weight (W) of the load weight calculation table 63 is zero (no load) (S19), and then uses this average value to overwrite the corrected pressure value (P′) corresponding to the no-load column of the load weight calculation table 63 (S21).

As explained above, according to this embodiment, occasionally executing this calibration eliminates the error factors due to changes in the weight of the lifting unit resulting from wearing, damage, corrosion, etc., of the bucket, bucket attachment/removal teeth, bucket pin, boom pin, etc., to make measurement with good accuracy possible.

In addition, the data acquired from the calibration during calibration of the load weight calculation table is not used to update the load weight calculation table but rather the average value of the data acquired from the calibration and the existing data of the load weight calculation table is obtained and this average value is used to update the load weight calculation table so that in the event the data received from the calibration is not a correct value, the effect of this error will not be 100%.

Embodiments of the present invention were explained above, but these embodiments are merely examples used to explain the present invention and these embodiments are not intended to limit the scope of the present invention. The present invention can perform a variety of other embodiments without deviating from this summary.

For example, the afore-mentioned embodiments only perform calibration on the load weight calculation table, but calibration can also be performed on the speed correction table.

1. A working machine for moving a load, comprising:
a lifting unit for lifting a load; a displacement detection device for detecting a displacement of said lifting unit; an actuator for driving said lifting unit; and a measurement device for measuring an output value or input value of said lifting unit; wherein said working machine comprises:
a detection value acquiring means for acquiring, during operation of said lifting unit, said displacement from said displacement detection device and said output value or input value from said measurement device;
a speed calculating means for obtaining a movement speed of said lifting unit during operation of said lifting unit;
a correcting means for obtaining a corrected value by correcting an output value or input value of said actuator in accordance with said movement speed of said lifting unit; and
a load weight calculating means for calculating a load weight based on said corrected value obtained by correcting said output value or input value of said actuator, and said displacement of said lifting unit from said detection value acquiring means.

2. The working machine for moving a load according to claim 1, further comprising:
a load weight calculation table that defines correlations among said corrected value, said displacement of said lifting unit, and said load weight;
wherein said load weight calculating means calculates said load weight referring to said load weight calculation table, based on said displacement from said displacement detecting device and said corrected value from said correcting means.

3. The working machine for moving a load according to claim 1, wherein
said lifting unit of said working machine has a boom;
said actuator includes a hydraulic cylinder for moving said boom;
said measurement device includes a pressure detection device for detecting a pressure of said hydraulic cylinder; and
said displacement detection device includes an angle detection device for detecting an angle of said boom.

4. The working machine for moving a load according to claim 1, wherein
said correcting means calculates a correction factor from said movement speed of said lifting unit and said output value or input value of said actuator, and
corrects said output value or input value of said actuator based on said correction factor and said movement speed of said lifting unit.

5. The working machine for moving a load according to claim 4, wherein
said correcting means comprises a speed correction table that defines correlations among said output value or input value of said actuator, said movement speed of said lifting unit, and said correction factor; and
calculates said correction factor based on said speed correction table.

6. A working machine for moving a load, comprising:
a lifting unit for lifting a load; a displacement detection unit for detecting a displacement of said lifting unit; an actuator for driving said lifting unit; and a measurement unit for measuring an output value or input value of said actuator; wherein said working machine comprises:
a load weight calculating means, having a load weight calculation table that defines correlations among said output value or input value of said actuator, said displacement of said lifting unit, and said load weight; acquiring, during operation of said lifting unit, said displacement from said displacement detection device and said output value or input value from said measurement device; and calculating said load weight referring to said load weight calculation table, based on said displacement acquired from said displacement detection device and said output value or input value acquired from said measurement device; and
a calibrating means for inputting a specified value of said load weight; acquiring, during calibration operation of said lifting unit, said displacement from said displacement detection device and said output value or input value from said measuring device; and calibrating said load weight calculation table based on said displacement acquired from said displacement detection device, said output value or input value acquired from said measurement device, and said specified load weight.

7. The working machine for moving a load according to claim 6, further comprising:
a speed calculating means for obtaining a movement speed of said lifting unit during operation of said lifting unit; and
a correcting means for obtaining a corrected value by correcting said output value or input value of said actuator in accordance with said movement speed of said lifting unit; wherein
said load weight calculation table records a numerical value for obtaining said load weight based on said corrected value by correcting said output value or input value of said actuator, and said displacement of said lifting unit; and
said load weight calculation means calculates said load weight referring to said load weight calculation table, based on said corrected value from said correcting means and the acquired displacement of said load lifting unit, and calibrates numerical values of said load weight calculation table.

8. The working machine for moving a load according to claim 7, wherein
said calibrating means, during calibration execution, calculates an average value of a numerical value acquired from current calibration and a numerical value currently registered in said load weight calculation table, and then uses said calculated average value as a post-calibration numerical value for calibrating said load weight calculation table.

9. The working machine according to claim 6, further comprising:
a clearing means for initializing said numerical values of said load weight calculation table to specified initial values.

10. A device for measuring a load weight of a working machine for moving a load, comprising:
a lifting unit for lifting a load; a displacement detection device for detecting a displacement of said lifting unit; an actuator for driving said lifting unit; and a measurement device for measuring an output value or input value of said lifting unit; wherein said device for measuring comprises:
a detection value acquiring means for acquiring, during operation of said lifting unit, said displacement from said displacement detection device and said output value or input value from said measurement device;
a speed calculating means for obtaining a movement speed of said lifting unit during operation of said lifting unit;
a correcting means for obtaining a corrected value by correcting an output value or input value of said actuator in accordance with said movement speed of said lifting unit; and
a load weight calculating means for calculating a load weight based on said corrected value obtained by correcting said output value or input value of said actuator, and said displacement of said lifting unit from said detection value acquiring means.

11. A method for measuring a load weight of a working machine for moving a load, comprising:
a lifting unit for lifting a load; a displacement detection unit for detecting a displacement of said lifting unit; an actuator for driving said lifting unit; and a measurement unit for measuring an output value or input value of said actuator; wherein said method comprises the steps of:
acquiring, during operation of said lifting unit, said displacement from said displacement detection device and an output value or input value from said measurement device;
obtaining a movement speed of said lifting unit during operation of said lifting unit;
obtaining a corrected value by correcting said output value or input value of said actuator in accordance with said movement speed of said lifting unit; and
calculating a load weight based on said corrected value obtained by correcting said output value or input value of said actuator, and said displacement of said lifting unit acquired from said displacement detection device.

12. A computer program executed by a computer for commanding a computer to perform the method according to claim 11.

13. The working machine for moving a load according to claim 2, wherein
said lifting unit of said working machine has a boom;
said actuator includes a hydraulic cylinder for moving said boom;
said measurement device includes a pressure detection device for detecting a pressure of said hydraulic cylinder; and
said displacement detection device includes an angle detection device for detecting an angle of said boom.

14. The working machine for moving a load according to claim 2, wherein
said correcting means calculates a correction factor from said movement speed of said lifting unit and said output value or input value of said actuator, and
corrects said output value or input value of said actuator based on said correction factor and said movement speed of said lifting unit.

15. The working machine for moving a load according to claim 14, wherein
said correcting means comprises a speed correction table that defines correlations among said output value or input value of said actuator, said movement speed of said lifting unit, and said correction factor; and
calculates said correction factor based on said speed correction table.
